(19) United States
(12) Patent Application Publication
(10) Pub. No.: US 2018/0211011 A1
(43) Pub. Date: Jul. 26, 2018

(54) ANESTHESIA ASSESSMENT SYSTEM AND METHOD FOR ENHANCED RECOVERY AFTER SURGERY QUALIFICATION

(71) Applicant: General Electric Company, Schenectady, NY (US)

(72) Inventors: Tali Gordon Ben-Ami, Madison, WI (US); Tom J. Haggblom, Helsinki (FI)

(73) Assignee: General Electric Company, Schenectady, NY (US)

(21) Appl. No.: 15/415,104

(22) Filed: Jan. 25, 2017

(51) Int. Cl. G06F 19/00

(52) U.S. Cl. CPC G06F 19/345; G06F 19/3406

(57) ABSTRACT

A system for assessing a patient in an enhanced recovery after surgery (ERAS) program includes an ERAS tracking module that receives identification of ERAS monitoring parameters for monitoring whether the patient is on track to qualify for the ERAS program, including at least one drug delivery parameter, adequacy of anesthesia parameter, and vital sign. The ERAS tracking module receives ERAS qualification criteria for postoperative qualification for the ERAS program, and determines intraoperative tracking targets for each ERAS monitoring parameter, wherein the intraoperative tracking target is a desired value for the ERAS monitoring parameter during surgery that indicates postoperative qualification for the ERAS program. The ERAS tracking module receives parameter values for each ERAS monitoring parameter during the surgical procedure and compares each parameter value to the respective intraoperative tracking target, then determines an ERAS tracking indicator based on the comparison of the parameter value to the respective intraoperative tracking target.

### BACKGROUND

Perioperative care is generally divided into three phases of surgery: preoperative, intraoperative, and postoperative. The preoperative phase is used to perform tests and provide preparatory mental and physical care to the patient prior to surgery. The intra-operative period begins when the patient is transferred to the operating room table and ends with the transfer of a patient to the intensive care unit (ICU) or postanesthesia care unit (PACU). During this period the patient is monitored, anesthetized, prepped, and draped, and the operation is performed. Nursing activities during this period focus on safety, infection prevention, and physiological response to anesthesia. The postoperative period begins after the transfer to the ICU or PACU and terminates with the resolution of the surgical sequelae. It is quite common for the very last of this period to end outside of the care of the surgical team.

Enhanced Recovery After Surgery (ERAS) programs, sometimes referred to as “fast-track” programs, are being implemented in perioperative management at an increasing number of medical facilities. The goal of ERAS programs is to achieve early recovery after a surgical procedure by maintaining preoperative organ function and reducing the profound stress response of a patient following surgery. For example, a typical ERAS program includes perioperative counselling, optimization of nutrition, standardized analgesic and anesthesia regimens during and after surgery, and early mobilization. Another goal of an ERAS program may be to avoid sending the patient to the intensive care unit (ICU) after surgery.

ERAS programs are used in a multitude of different types of surgery, including cardiac surgery, vascular surgery, thoracic surgery, colorectal surgery, radical cystectomy, or the like. The steps and requirements of a particular ERAS program are tailored to the type of surgical procedure, and the recovery requirements and milestones therefore. These programs attempt to modify the physiological and psychological responses to major surgery, and have been shown to lead to a reduction in complications and hospital stay, improvements in cardio pulmonary function, earlier resumption of normal activities, and the like.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In one embodiment, an anesthesia assessment system for monitoring a patient in an enhanced recovery after surgery (ERAS) program includes an ERAS tracking module executable on a processor to receive identification of ERAS monitoring parameters for monitoring whether the patient is on track to qualify for the ERAS program, wherein the ERAS monitoring parameters include at least one drug delivery parameter, at least one adequacy of anesthesia parameter, and at least one vital sign. The ERAS tracking module is further executable to receive one or more ERAS qualification criteria for postoperative qualification for the ERAS program, and to determine at least one intraoperative tracking target for each ERAS monitoring parameter in the identified list of ERAS monitoring parameters, wherein the intraoperative tracking target is a desired value for the ERAS monitoring parameter during surgery that pertains to postoperative qualification for the ERAS program, such as postoperatively meeting the ERAS qualification criteria. The ERAS tracking module is further executable to receive at least one parameter value for each ERAS monitoring parameter during the surgical procedure and to compare each parameter value to the respective intraoperative tracking target. The ERAS tracking module determines an ERAS tracking indicator based on at least one comparison of the parameter value to the respective intraoperative tracking target, wherein the ERAS tracking indicator indicates whether the patient is on track to meet the ERAS qualification criteria. The system further includes a display that displays the ERAS tracking indicator.

In one embodiment, a method of monitoring a patient during surgical operation to qualify the patient for an ERAS program includes determining that the patient is a candidate for the ERAS program, and receiving a list of ERAS monitoring parameters for monitoring whether the patient is on track to qualify for the ERAS program. The list of ERAS monitoring parameters includes at least one drug delivery parameter, at least one adequacy of anesthesia parameter, and at least one vital sign. The method further includes receiving one or more ERAS qualification criteria for postoperative qualification for the ERAS program, and determining at least one intraoperative tracking target for the at least one ERAS monitoring parameter in the list of ERAS monitoring parameters, wherein the intraoperative tracking target is a desired value for the ERAS monitoring parameter during surgery that indicates that the patient is likely to postoperatively meet of the respective ERAS qualification criteria. The method further includes recording at least one parameter value for each ERAS monitoring parameter during the surgical procedure, comparing each parameter value to the respective intraoperative tracking target for the ERAS monitoring parameter, and generating an ERAS tracking indicator indicating whether the patient is on track to meet the ERAS qualification criteria based on at least comparison based of the parameter value to the respective intraoperative tracking target.

Various other features, objects, and advantages of the invention will be made apparent from the following description taken together with the drawings.

### BRIEF DESCRIPTION OF THE DRAWINGS

The present disclosure is described with reference to the following Figures.

FIG. 1 depicts one embodiment of an anesthesia assessment system for monitoring a patient in an enhanced recovery after surgery program.

FIG. 2 depicts one embodiment of a computing system in an anesthesia assessment system of the present disclosure.

FIG. 3A depicts one embodiment of a user interface for receiving user input indicating whether a patient satisfies exemplary ERAS candidate criteria.

FIG. 3B depicts one embodiment of a display displaying exemplary ERAS tracking indicators.

FIG. 3C depicts one embodiment of a user interface displaying an ERAS qualification status.

FIG. 4 depicts one embodiment of a method of monitoring a patient undergoing a surgical operation to qualify the patient for an ERAS program.

### DETAILED DESCRIPTION

Through significant experimentation, research, and experience in the relevant field, the present inventors have recognized a need for systems and methods that track a patient's status in qualifying for a particular ERAS program. For example, the inventors recognized that clinicians need a system that monitors a patient's drug delivery parameters, adequacy of anesthesia parameters, and vital signs during surgery to determine whether that patient is on track to postoperatively meet the ERAS qualification criteria for an ERAS program. Likewise, clinicians need a system that indicates which values are not on target for meeting the ERAS qualification criteria, and how much of a discrepancy exists. Further, the inventor recognized that further value could be provided by a system that identifies and indicates changes that can be made to the patient's treatment regimen in order to increase the probability that the patient will meet the postoperative ERAS qualification criteria.

Various ERAS programs are developed and utilized for different surgical procedures, or types of surgical procedures. Each ERAS program has a set of ERAS qualification criteria—a defined set of postoperative criteria based upon which a patient is qualified or disqualified from an ERAS program.

The inventors has recognized that, too often, patients who may have otherwise been able to qualify for an ERAS program had to be admitted to the ICU due to over usage or over dosage of anesthetic drugs during surgery, as well as failure to deliver lung protective ventilation, leading to delayed extubation and/or postoperative pulmonary complications which disqualify patients from ERAS programs. Thus, the inventors recognized the need for a system and method for monitoring a patient intraoperatively to determine whether they are on track for qualifying for a relevant ERAS program. Further, the inventors recognized that such a system could also enable a preselection of patients who are candidates for a particular ERAS program and provide clinicians with concrete assessments and values of a patient's trajectory toward qualification throughout the surgical procedure.

Additionally, the inventors recognized a need for a system that allows overall assessment of an ERAS program, including providing data upon which ERAS candidate criteria and ERAS qualification criteria can be modified to optimize patient outcomes and the effectiveness of an ERAS program.

In view of the foregoing problems and needs in the relevant art recognized by the inventors, the presently disclosed system was developed that utilizes adequacy of anesthesia assessments, which may include pharmacokinetic/pharmacodynamic (PK/PD) modeling, ventilation information and/or intravenous (IV) drug delivery information, patient vital signs, and/or information from the patient's medical record, to allow a clinician to best treat a patient to meet the ERAS qualification criteria for a particular ERAS program. For example, such monitoring allows anesthesia providers to prevent anesthetic drug overdose so that patient's emerging from general anesthesia procedures, such as cardiac surgery, will be able to avoid ICU stay during the recovery phase. By limiting a patient's drug exposure, patients are able to more quickly regain control of their airway and become fully aware and awake in an expedited amount of time, such as within less than six hours after cardiac surgery.

The inventors has recognized that, for many patients, better overall outcomes are achieved by avoiding the intensive care unit (ICU) after surgery and by expediting the patient's pathway to regaining consciousness. For example, patients in the ICU are often overmedicated, which can lead to slower overall postoperative recovery and/or to other postoperative complications. Moreover, avoiding placing patients in the ICU postoperatively can provide huge benefits to healthcare facilities. For example, monitoring a patient in a lower-acuity unit saves thousands of dollars per day per patient compared to caring for that same patient in the ICU. Moreover, ICU capacity is often a bottleneck for a surgical facility, where operating room capacity may not be fully utilized because the ICU is unable to accommodate patients postoperatively. Thus, ERAS programs can allow a healthcare facility to effectively manage its operating schedule to reduce reliance on the ICU and maximize the number of procedures performed in a time period. Similarly, incorporating ERAS tracking into intraoperative monitoring enables improved ICU workflow planning and management, and early detection and notification can be provided when an ERAS candidate patient is not likely to qualify for the ERAS program. Additionally, an important benefit of the anesthesia assessment system 1 disclosed herein is that it reduces variability of care among anesthesia providers, and increases the rigor of delivering anesthetic drugs and ventilation therapy based on patient monitoring and modelling parameters. Standardized care leads to predictable outcomes that allow for better resource planning (e.g. ICU capacity, cost of care). Every patient is different, and by using the anesthesia assessment system 1 disclosed herein providers are able to systematically customize care to each patient to achieve overall consistent results.

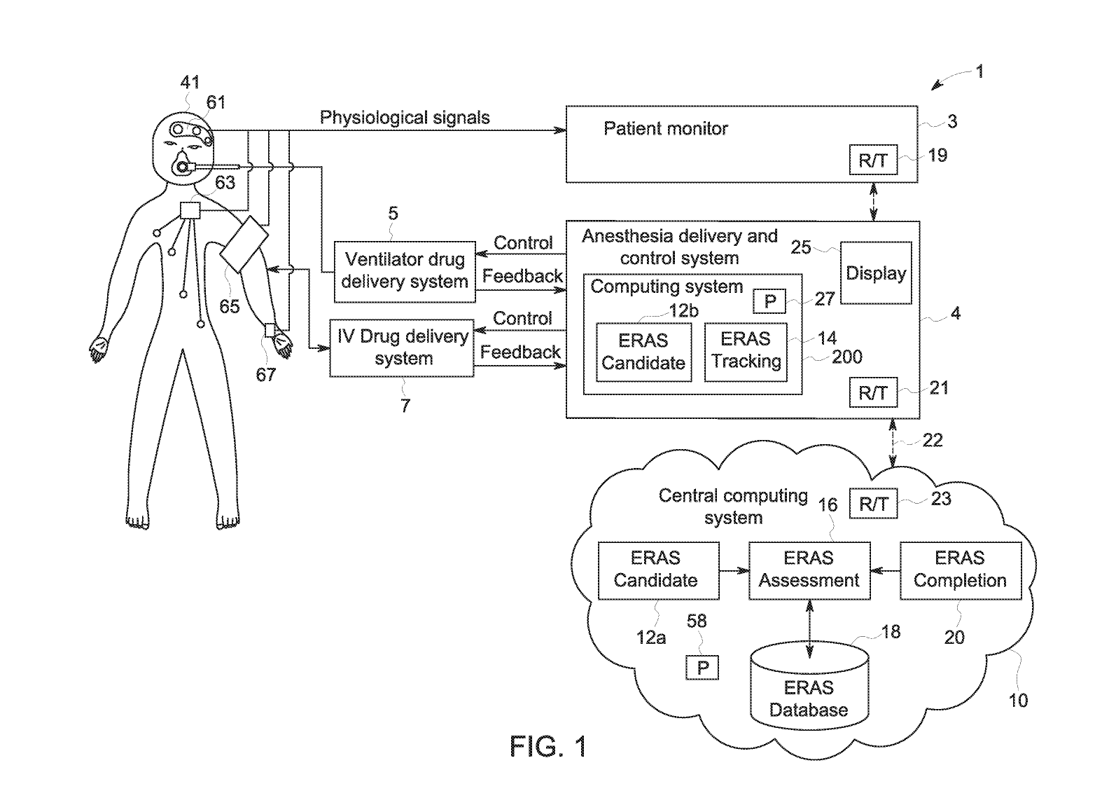

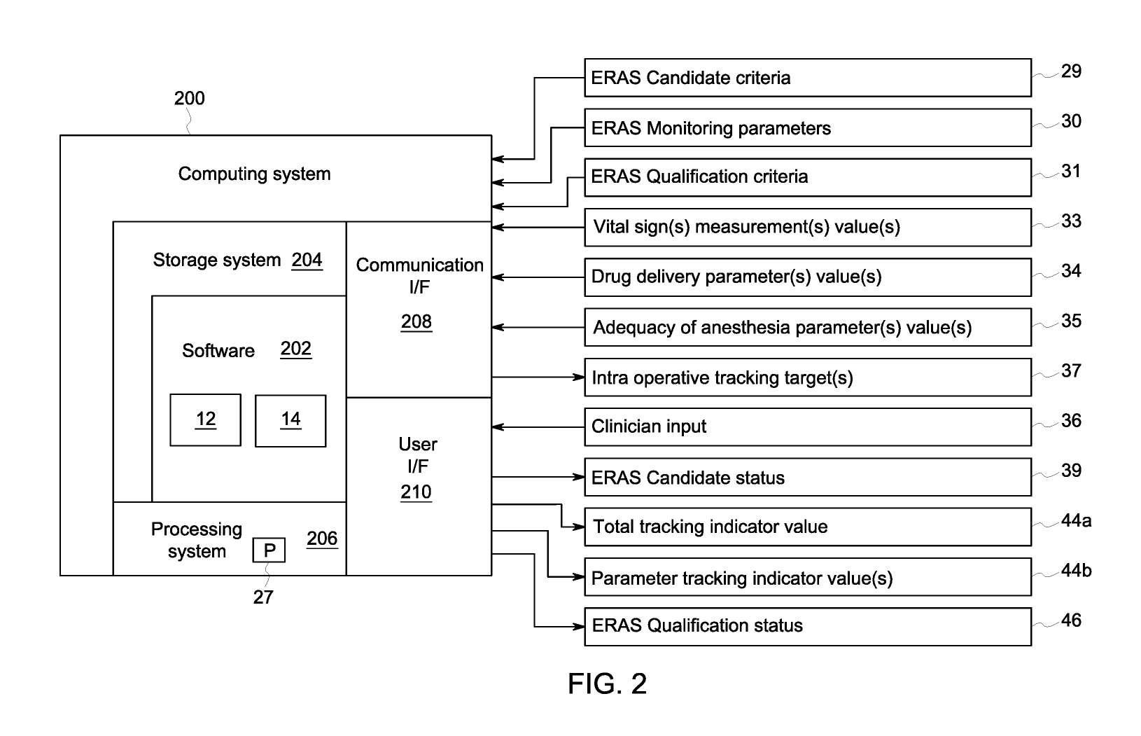

FIG. 1 depicts one embodiment of an anesthesia assessment system 1 wherein the anesthesia patient monitor 3 is communicatively connected to an anesthesia delivery and control system 4, which has an ERAS tracking module 14 executable on a processor of the computing system 200 to determine intraoperative tracking targets 37 and display an ERAS tracking indicator 44 on a display 25 on or associated with the anesthesia assessment system 1. The anesthesia assessment system 1 includes a ventilator drug delivery system 5 that delivers gaseous anesthesia via mechanical ventilation and an IV drug delivery system 7, such as including pumps that deliver intravenous anesthesia drugs to the patient 41. The anesthesia patient monitor 3 receives vital sign parameter values 33 based on physiological signals recorded from the patient 41. The anesthesia patient monitor 3 communicates the vital sign parameter values 33 and/or the recorded physiological data to the anesthesia delivery and control system 4. The anesthesia delivery and control system 4 further receives drug delivery parameter values 34 from the ventilator drug delivery system 5 and/or the IV drug delivery system 7, which provide information on the amount of anesthesia being delivered to the patient 41. Specifically, the ERAS tracking module 14 receives the vital sign parameter value(s) 33 and/or drug delivery parameter value(s) 34, and may further receive adequacy of anesthesia parameter values 35, which are determined based on the physiological signals recorded from the patient 41. As will be understood by a person having ordinary skill in the art, the embodiment of the system 1 depicted in FIGS. 1 and 2 is exemplary, and various other system configurations are known that can be utilized with equal effectiveness.

The ventilation delivery system 5 and the IV drug delivery system 7 are controlled by the anesthesia delivery and control system 4, which also receives feedback from each drug delivery system 5, 7 which is incorporated into the control algorithm. For example, the anesthesia delivery and control system 4 may automatically control ventilation to the patient 41, such as automatically controlling the content of the gas delivered to the patient 41 via the ventilator drug delivery system 5. Such automatic control may incorporate the relevant intraoperative tracking targets 37 into its control algorithm in order to automatically control ventilation to meet those intraoperative tracking targets 37. Such automatic control will avoid overdosing the patient with inhalant anesthesia, and thus will expedite patient extubation after completion of the surgical procedure. The anesthesia patient monitor 3 also receives physiological signals from the patient 41, which may include a multitude of different physiological signals relating to the patient's neurological activity (e.g. brain and/or peripheral nerve activity), cardiac activity, circulation, respiration, or the like. Such physiological signals are used to provide the automatic ventilation control as well as for control of the intravenous drug delivery system 7 so that the total amount of anesthesia delivered to the patient is minimized as much as possible and unnecessary delays to patient extubation and alertness after completion of the surgical procedure may be avoided.

In one embodiment, the ERAS tracking module 14 receives identification of ERAS monitoring parameters 30 for determining whether the patient 41 is on track to qualify for an ERAS program. The ERAS monitoring parameters 30 include at least one drug delivery parameter, at least one adequacy of anesthesia parameter, and/or at least one vital sign. The drug delivery parameter regards the amount of anesthetic drug delivered to a patient 41, the concentration of the drug in the patient's body, and/or the effect of the drug on the patient 41. To provide just some examples, the at least one drug delivery parameter values 34 in the ERAS monitoring parameters 30 may include drug dosage information for one or more anesthesia drugs being delivered to the patient and/or effect-site concentration values, such as anesthetic concentration determined using PK/PD modeling. The adequacy of anesthesia parameter regards the level of sedation, analgesia, and relaxation of the patient 41. Examples of the adequacy of anesthesia parameter values 35 may include one or more of a depth of consciousness or depth of sedation value, such as Entropy, Bispectral Index (BIS), and/or reaction to nociceptive stimulus monitoring, such as Surgical Pleth Index, (PSI), and/or depth of relaxation monitoring, such as Neuromuscular Transmission (NMT), etc. The list of ERAS monitoring parameters 30 further includes at least one vital sign, such as blood pressure, heart rate, respiration rate, blood oxygenation, etc. In the depicted embodiment, physiological signals are received from an electroencephalograph or depth of anesthesia monitor 61, an electrocardiograph monitor 63, a non-invasive blood pressure (NIBP) monitor 65, and a neuromuscular transmission (NMT) measurement module 67. One of skill in the art will understand in light of this disclosure that any physiological monitoring devices may be utilized to record physiological signals from the patient 41, from which various parameter values (e.g., vital sign parameter values 33 and adequacy of anesthesia parameter values 35) may be isolated, determined, or derived.

The ERAS tracking module 14 is further configured to receive at least one ERAS qualification criteria 31 for postoperative qualification for the ERAS program. Namely, the ERAS qualification criteria 31 is a set or list of requirements that a patient must meet following surgery in order to qualify for the relevant ERAS program. For example, an exemplary list of ERAS qualification criteria 31 may require that the patient 41 be awake, aware, and spontaneously breathing prior to leaving the operating room, or within a predetermined amount of time from concluding the operating procedure. Alternatively or additionally, the ERAS qualification criteria 31 may include any other parameters that may be indicative of whether a patient is going to be capable of expedited recovery without the additional support of going to the ICU. For instance, the ERAS qualification criteria 31 may include a minimum alveolar concentration (MAC) value below a certain level indicating minimal anesthesia presence, such as a MAC value at or below 0.1. Alternatively or additionally, the ERAS qualification criteria 31 may include a minimum entropy value, a particular neuromuscular transmission (NMT) value, such as a particular numerically expressed train-of-four ratio (TOF percent). Alternatively or additionally, the ERAS qualification criteria 31 may include maintenance of a threshold body temperature for the patient 41. In still other embodiments, ERAS qualification criteria 31 may include heart rate, blood pressure, etc., or particular physiological measurements relevant to the patient's recovery from the surgical procedure.

The ERAS tracking module 14 determines one or more intraoperative tracking targets 37 for each ERAS monitoring parameter 30. For example, ERAS intraoperative tracking targets 37 are set for each drug delivery parameter, each adequacy of anesthesia parameter, and each vital sign within the list of ERAS monitoring parameters 30. The intraoperative tracking target is a desired value for each ERAS monitoring parameter 30 during surgery that enables postoperative achievement of the ERAS qualification criteria 31. For example, the intraoperative tracking targets 37 may include target values or value ranges for each ERAS monitoring parameter 30 at a given point in the surgical procedure. To provide just one explanatory example, the intraoperative tracking targets 37 may include target values for each ERAS monitoring parameter 30 at the beginning of the surgical procedure (such as at the time of incision), at various milestones during the procedure, at an end point of the procedure (such as at the time of closing the incision), and at the point of completion of the procedure. Thereby, parameters, or guide points, are set by the intraoperative tracking targets 37 upon which a clinician can determine whether the patient 41 is on track to meet the ERAS qualification criteria 31 postoperatively.

One or more of the intraoperative tracking targets 37 for certain ERAS monitoring parameters 30 may be set based on a baseline measurement for that parameter measured at an early point in the surgical procedure, such as prior to delivery of anesthesia or at an early point in the delivery of anesthesia, such as prior to or immediately after intubation. Such early measurements can establish a patient-centric baseline upon which the patient's progress can be determined. For example, a nociceptive baseline can be determined when the patient is under light anesthesia, and such baseline can serve as an intraoperative tracking target for the nociceptive response at the end of the procedure as the patient is emerging out of anesthesia. Other intraoperative tracking targets 37 may be determined based on information from the patient's medical record, population normal values, or the like. In other embodiments, intraoperative tracking targets 37 may be determined based on values inputted by a clinician.

After completion of the surgery, the ERAS tracking module 14 may further be executed within the computing system 200 to automatically determine whether the patient meets the ERAS qualification criteria 31, and thus whether the patient qualifies for the ERAS program. For example, the ERAS tracking module 14 may continue to receive parameter values 33, 34, 35 for one or more of the ERAS monitoring parameters 30 for a predetermined maximum period of time after conclusion of the surgical procedure (such as after moving the patient of the operating table and onto a hospital bed). The ERAS tracking module 14 may comprise instructions executable to determine whether such postoperatively received parameter values meet the ERAS qualification criteria 31. For example, the ERAS tracking module 14 may assess whether the patient's vital signs and/or adequacy of anesthesia indicate that ERAS qualification criteria 31 are met indicating that the patient is sufficiently awake and aware. Likewise, respiration parameter values may be monitored to determine that the patient is breathing on their own and can be extubated successfully.

The ERAS tracking module 14 may then generate an ERAS qualification status 46 indicating whether the patient 41 qualified for the ERAS program. For example, the ERAS qualification status 46 may be a binary variable where a positive value indicates that the patient 41 qualified for the ERAS program and a zero, or negative, value when the patient 41 did not qualify for the ERAS program. The ERAS qualification status 46 may then be presented on display 25 of the anesthesia delivery and control system 4 to indicate to the clinician whether the patient 41 has satisfied the ERAS qualification criteria 31 and thus qualifies for the ERAS program—e.g., whether the patient can proceed to the PACU or other step-down unit, or needs to be admitted to the ICU. It shall be understood that the ERAS qualification status 46, as well as the ERAS tracking indicator

The anesthesia assessment system 1 may further be configured to determine whether a particular patient 41 is a candidate for an ERAS program—i.e. the patient's ERAS candidate status 39. A patient's candidacy for a particular ERAS program is preferably determined before beginning a surgical procedure, and preferably well in advance of the procedure. One embodiment of the system 1 comprises an ERAS candidate module 12 executable to receive ERAS candidate criteria for determining whether the patient 41 is a candidate for the particular ERAS program associated with a surgery for which the patient 41 is scheduled or will be scheduled. The ERAS candidate module then determines whether the patient satisfies the ERAS candidate criteria 29. For example, the ERAS candidate module 12 may be executable to automatically determine whether the patient 41 satisfies the ERAS candidate criteria 29 based on information available from the patient's medical record.

In various embodiments of the system 1, the ERAS candidate module 12 may be stored and executed by the central computing system 10, the anesthesia delivery and control system 4, or both. Alternatively or additionally, certain functions or steps may be performed by the patient monitor 3. The ERAS candidate module 12 may be stored in and executable by the computer system 200 within the anesthesia delivery and control system 4, and thus the ERAS candidate assessment may be conducted immediately prior to commencement of the surgical procedure. Alternatively or additionally, the ERAS candidate module 12 may be stored on and executed by a central computing system 10 which may be networked to the anesthesia delivery and control system 4. Such an embodiment is depicted in the system diagram of FIG. 1, where the ERAS candidate module 12 is stored on and executable by the central computing system (ERAS candidate module 12a) and also stored on and executable by the computing system 200 within the anesthesia delivery and control system 4 (ERAS candidate module 12b). In such an embodiment, the candidate analysis may be conducted prior to the date of surgical procedure, such as including it as part of the scheduling protocol for a surgical procedure. The ERAS candidate module 12a may be utilized to determine whether the patient 41 is a candidate for the relevant ERAS program by assessing the ERAS candidate criteria 29 for that program against the information in the patient's medical record. Such information may be utilized in the scheduling process, such as to predict or determine ICU load. Then the ERAS candidate module 12b on the anesthesia delivery and control system 4 may be executed immediately prior to surgery to recheck the patient's candidacy, such as based on an updated medical record for the patient and/or based on physiological signals received from the patient 41 immediately prior to the candidacy assessment.

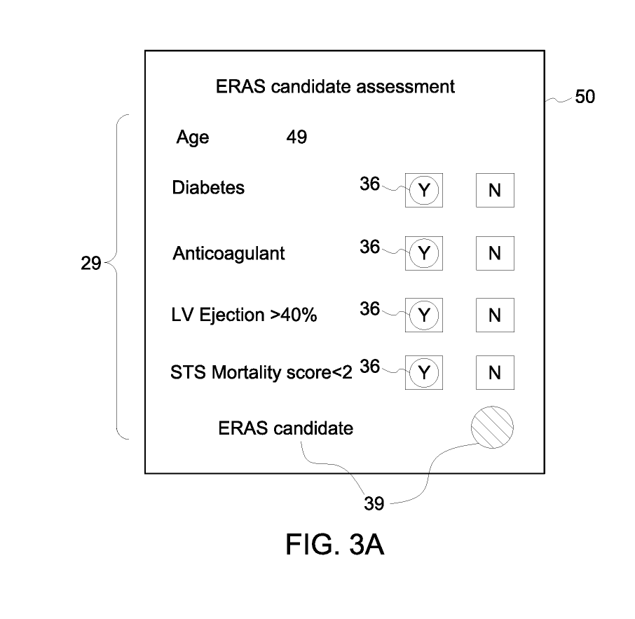

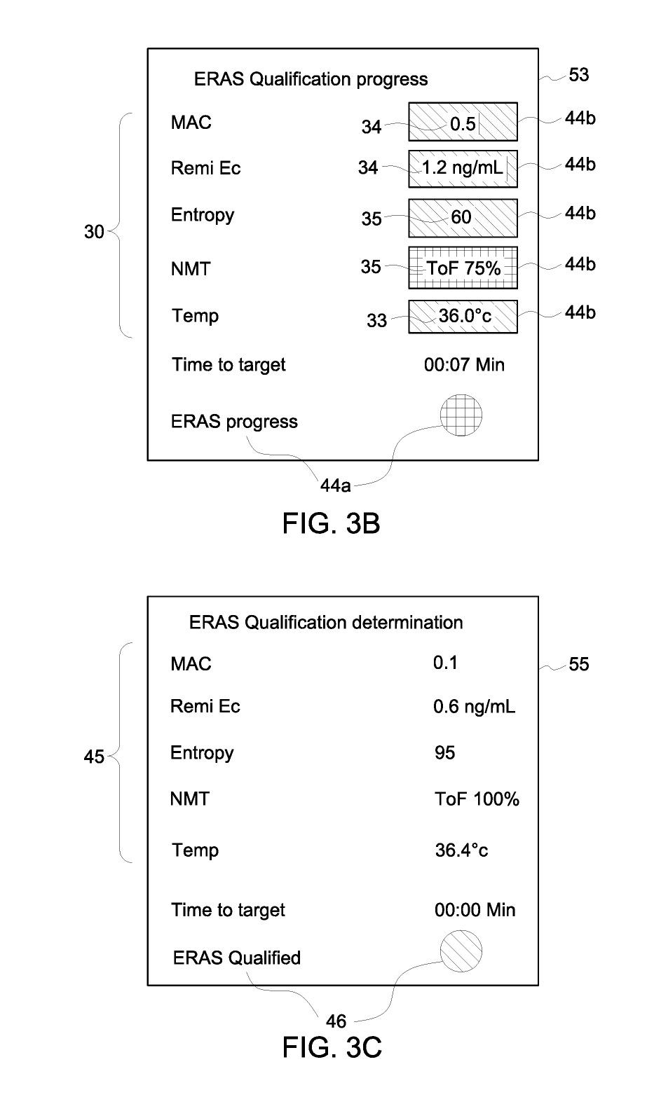

FIG. 3A depicts one embodiment of a user interface 50 that may be utilized to input information to an ERAS candidate module 12 by which the ERAS candidate criteria 29 can be assessed. The exemplary user interface 50 through which clinician input 36 of information pertinent to the ERAS candidate criteria 29 can be provided. In the example, the ERAS candidate criteria include an assessment of whether the patient is below a threshold age, has diabetes, is prescribed an anticoagulant, has a left ventricle ejection fraction of greater than 40%, and has a relatively low risk of operative mortality and morbidity, which is represented on the depicted embodiment as an STS mortality score of less than two. In the depicted embodiment, the clinician provides input 36 into the user interface 50 by selecting the yes button or no button for reach criteria, and the ERAS candidate module 12 then determines whether the patient satisfies the ERAS candidate criteria 29 based on the information inputted by the clinician. The ERAS candidate module 12 may then generate an ERAS candidate status 39 indicating whether the patient 41 has qualified for an ERAS candidate. In the depicted embodiment, the ERAS candidate's status 39 is indicated on the user interface 50 as a green indicator, indicating to the clinician that the patient 41 has qualified as an ERAS candidate. In other embodiments, the ERAS candidate status 39 may be communicated by other means, which may include any visual or auditory communication means, and may be by a user interface on the anesthesia delivery and control system 4 and/or user interface associated with the central computing system 10. For example, the ERAS candidate status 39 indicator may be displayed on the display 25 of the anesthesia delivery and control system 4. In other embodiments where the candidacy is determined by an ERAS candidate module 12a associated with the central computing system 10, the ERAS candidate status 39 may be presented to the clinician by any display associated with a computing device accessing the central computing system 10.

In other embodiments, the ERAS candidate module 12 may automatically access information from the patient's medical record to determine whether the ERAS candidate criteria 29 are met, and thus to automatically assess and determine whether the patient is a candidate for the relevant ERAS program pertaining to the surgical procedure being performed or being scheduled for that patient 41.

Once the surgical procedure is underway, the ERAS tracking module 14 tracks the patient's progress toward meeting the ERAS qualification criteria 31 as is described above. FIG. 3B depicts one embodiment of a display 53 providing the ERAS tracking indicator 44a, 44b during a surgical procedure. In the depicted example, the “time to target” demonstrates the expected time for the patient to emerge from anesthesia, which is a preset time, or time range, following the conclusion of the surgical procedure at which point the patient 41 should be assessed to determine whether they meet the ERAS qualification criteria 31. For example, the “time to target” value may be calculated based on the PK/PD value. Some or all of the list of ERAS monitoring parameters 30 are displayed, with a parameter tracking indicator 44b indicating whether the parameter value(s) for the respective ERAS monitoring parameter is equal to or within a predetermined range of the intraoperative tracking target 37 for that ERAS monitoring parameter 30. As described above, the intraoperative tracking target 37 may be a defined value, and the ERAS tracking module may assess whether the parameter values are within a predefined range of the respective intraoperative tracking target 37. In other embodiments, the intraoperative tracking target 37 may be a range of acceptable values for the parameter value for that ERAS monitoring parameter 30, and thus the ERAS tracking module 14 assesses whether the most recent parameter value or set of parameter values fall within the range established by the intraoperative tracking target 37.

In either instance, if the parameter value (e.g. 33-35) for an ERAS monitoring parameter 30 meets the respective intraoperative tracking target 37, then the parameter tracking indicator 44b may indicate that the patient is on track with respect to that parameter. In the depicted embodiment, the display 53 shows the parameter values for five ERAS monitoring parameters 30, including vital sign parameter value 33 of temperature, adequacy of anesthesia parameter values 35 of neuromuscular transmission and entropy, and drug delivery parameter values 34 of the effect-site concentration of reminfentanil and the minimum alveolar concentration. Each respective parameter value is displayed or highlighted in a particular color, which communicates the relevant parameter tracking indicator 44b for that parameter. In the depicted example, all of the parameter values meet the requirements of the respective intraoperative tracking target 37, and thus are displayed in green, with the exception of the neuromuscular transmission value, which is displayed in yellow indicating that the respective adequacy of anesthesia parameter value 35 of the train of four is slightly below the intraoperative tracking target for neuromuscular transmission at the relevant “time to target” of seven minutes.

The ERAS tracking module 14 may further determine a total tracking indicator 44a for two or more of the ERAS monitoring parameters 30 in the depicted embodiment the total tracking indicator 44a is determined based on the parameter values 33-35 for the ERAS monitoring parameters 30, and the total tracking indicator 44a is assigned a value of “yellow”, or a cautionary value, to alert the clinician to the fact that one of the ERAS monitoring parameters is not meeting the respective intraoperative tracking target.

For example, the total tracking indicator 44a and the parameter tracking indicator 44b may each be assigned a value of “green” if the parameter value meets the respective intraoperative tracking target, such as within a first predetermined range of the respective intraoperative tracking target 37. The parameter tracking indicator 44b may be assigned a value of “yellow” if the parameter value 33-35 is within a second predetermined range of the respective intraoperative tracking target 37, and assigned a value of “red” if the respective parameter value 33-35 is outside of the second predetermined range of the respective intraoperative tracking target 37. Thus, any particular ERAS monitoring parameter 30 that is not meeting the respective tracking target 37 will be highlighted for the clinician by the parameter tracking indicator 44b.

As described above, the ERAS tracking module 14 may also contain instructions executable to receive at least one postoperative parameter value, e.g. ERAS qualification parameters 45, and determine whether the patient meets the ERAS qualification criteria 31. FIG. 3C depicts one embodiment of a display 55 showing ERAS qualification criteria 31 and the postoperative parameter values for the patient at the time of the fast track qualification assessment. In the depicted embodiment, the ERAS tracking module 14 determines an ERAS qualification status 46 based on a comparison of the relevant postoperative parameter values and the ERAS qualification criteria 31 for the depicted qualification parameters 45, which in the depicted embodiment are the same as the ERAS monitoring parameters 30. In other embodiments, the ERAS qualification parameters 45 for which ERAS qualification criteria 31 are provided may be different than the ERAS monitoring parameters 30 monitored during the surgical procedure to determine whether the patient is on track.

The postoperative parameter values for each of the ERAS qualification parameters 45 are measured against the respective ERAS qualification criteria 31 to determine whether the patient qualifies for the ERAS program. If so, an ERAS qualification status 46 may be generated, which as described above indicates whether or not the patient 41 actually qualified for the ERAS program at the conclusion of the surgical procedure. If so, the patient 41 will be transferred to the PACU or some other step-down care unit, for example, rather than being transferred to the ICU. For example, the display 55 showing the ERAS qualification status 46 may be provided on the display 25 of the anesthesia delivery and control system 4. Alternatively or additionally, the display 55 showing the ERAS qualification status 46 may be provided on a display associated with the central computing system 10.

In certain embodiments of the anesthesia assessment system 1, the anesthesia delivery and control system 4 may communicate with a central computing system 10, which may be via wired or wireless means. In such an embodiment, the computing system 200 executing instructions comprising the ERAS candidate module 12b or the ERAS tracking module 14 may communicate with the central computing system 10, such as to transmit information to and/or receive information from a patient medical record database and/or an ERAS database 18. The ERAS database 18 may comprise an ERAS patient record for each patient 41 that qualifies as a candidate for an ERAS program. Alternatively or additionally, the ERAS database 18 may comprise an ERAS patient record for each patient assessed by an ERAS candidate module 12. In certain embodiments, the ERAS patient record includes at least one of the ERAS candidate status 39 and the ERAS qualification status 46 for each patient. Additionally, the ERAS patient records in the ERAS database 18 may further comprise the ERAS candidate criteria 29, ERAS monitoring parameters 30, and ERAS qualification criteria 31 for the relevant patient 41. Additionally, each ERAS patient record may include one or more vital sign parameter values 33, drug delivery parameter values 34, and adequacy of anesthesia parameter values 35.

The parameter values and/or ERAS candidate status 39 and ERAS qualification status 46 may be transmitted from the anesthesia delivery and control system 4 to the central computing system 10, such as a central network for a medical care facility, via wired or wireless means in the embodiment depicted in FIG. 1, the anesthesia delivery and control system 4 communicates with the central computing system 10 via wireless communication link 22. The anesthesia patient monitor 3 may communicate with the anesthesia delivery and control system 4 by wired or wireless means, and in certain embodiments may also communicate directly with the central computing system 10. In the depicted embodiment, the anesthesia patient monitor 3 is equipped with a wireless receiver/transmitter 19 that communicates wirelessly with a receiver/transmitter 21 of the anesthesia delivery and control system 4. Similarly, the anesthesia delivery and control system 4 is equipped with a wireless receiver/transmitter 21 that communicates wirelessly with a receiver/transmitter 23 associated with the central computing system 10. The receiver/transmitters 19, 21, 23 may be any radio frequency devices configured to communicate via any wireless communication protocol, such as a network operating on the wireless medical telemetry service (WMTS) spectrum or on a Wi-Fi compliant local network (WLAN). In still other embodiments, two or more of the receiver/transmitters 19, 21, 23 may be configured to communicate via other radio protocols, such as Bluetooth, Bluetooth Low Energy (BLE), ANT, or ZigBee. Communication between the receiver transmitters 19 and 21 may be via the same or different protocol than communication between receiver transmitters 21 and 23.

In certain embodiments, the ERAS-related solution provided by the anesthesia assessment system 1 includes one or more software modules in one or both of the computing system 200 of the anesthesia delivery and control system 4 and the central computing system 10 that perform the functions described herein. While the embodiment depicted in FIG. 1 provides the ERAS tracking module 14 entirely in the computing system 200, in other embodiments, the ERAS tracking module 14 may be contained partly or wholly in the central computing system 10. Similarly, the ERAS assessment module 16 and/or the ERAS completion module 20 (described below) is depicted in FIG. 1 as being wholly contained in the central computing system 10; however, in other embodiments some or all of the functionally attributed to the ERAS assessment module 16 and/or the ERAS completion module 20 may be executed by instructions stored in the computing system 200 of the anesthesia delivery and control system 4.

FIG. 2 provides a system diagram of an exemplary embodiment of a computing system 200 in an anesthesia delivery and control system 4 having an ERAS candidate module 12 and an ERAS tracking module 14 executable to carry out the analysis and method steps described herein. The computing system 200 includes a processing system 206, storage system 204, software 202, communication interface 208 and a user interface 210. The processing system 206 loads and executes software 202 from the storage system 204, including the ERAS candidate module 12 and the ERAS tracking module 14, which are applications within the software 202. Each of the modules 12, 14 (and the ERAS assessment module 16 and ERAS completion module 20 associated with the central computing system 10) include computer-readable instructions that, when executed by the processing system 206 or (a processing system of the central computing network 10), direct the operation as described in herein in further detail.

Although the computing system 200 as depicted in FIG. 2 includes one software 202 encapsulating one ERAS candidate module 12 and one ERAS tracking module 14, it should be understood that one or more software elements having one or more modules may provide the same operation. Similarly, while description as provided herein refers to a computing system 200 and a processing system 206, it is to be recognized that implementations of such systems can be performed using one or more processors, which may be communicatively connected, and such implementations are considered to be within the scope of the description.

The processing system 206 includes the processor 27, which may be a microprocessor, a general purpose central processing unit, and application-specific processor, a microcontroller, or any other type of logic-based device. The processing system 206 may also include circuitry that retrieves and executes software 202 from storage system 204. Processing system 206 can be implemented within a single processing device but can also be distributed across multiple processing devices or sub-systems that cooperate in executing program instructions.

The storage system 204 can comprise any storage media, or group of storage media, readable by processing system 206, and capable of storing software 202. The storage system 204 can include volatile and non-volatile, removable and non-removable media implemented in any method or technology for storage of information, such as computer-readable instructions, data structures, program modules, or other data. Storage system 204 can be implemented as a single storage device but may also be implemented across multiple storage devices or sub-systems. Examples of storage media include random access memory, read only memory, optical discs, flash memory, virtual memory, and non-virtual memory, magnetic sets, magnetic tape, magnetic disc storage or other magnetic storage devices, or any other medium which can be used to store the desired information and that may be accessed by an instruction execution system, as well as any combination or variation thereof, or any other type of storage medium. Likewise, the storage media may be housed locally with the processing system 206, or may be distributed in one or more servers, which may be at multiple locations and networked, such as in cloud computing applications and systems. In some implementations, the storage media can be a non-transitory storage media. In some implementations, at least a portion of the storage media may be transitory.

The communication interface 208 interfaces between the elements within the computing system 200 and external devices, such as with physiological monitoring systems collecting physiological data (e.g. vital sign data) from the patient, the ventilator delivery system 5, the IV drug delivery system 7, the display 25, the receiver/transmitter 21, and the like.

The user interface 210 is configured to receive input 36 from a clinician, and to display the candidate status 39 indicator and/or the ERAS qualification status 46, such as the displays depicted in FIGS. 3A-3C. User interface 210 includes display 25, such as a digital display, and may further include a mouse, a keyboard, a voice input device, a touch input device for receiving a gesture from a user (such as where the display 25 is a touchscreen), a motion input device for detecting non-touch gestures and other motions by a user, and other comparable input devices and associated processing elements capable of receiving input from a user, such as a clinician. Output devices such as a video display or graphical display can display an interface further associated with embodiments of the system and method as disclosed herein. Speakers, printers, haptic devices and other types of output devices may also be included in the user interface 210.

In certain embodiments, the anesthesia assessment system 1 may include an ERAS assessment module 16 executable on one or more processors 58 within the central computing system 10 to provide overall assessment and/or feedback on an ERAS program and/or the criteria associated therewith. In one embodiment, the ERAS assessment module 16 determines a number of candidates that have qualified for a particular ERAS program, and in certain embodiments the ERAS assessment module 16 may generate a list of patients that are candidates for the ERAS program (such as by meeting the ERAS candidate criteria 29 as described herein). Additionally the ERAS assessment module 16 may determine a number of those candidates that have set aside the ERAS qualification criteria 31 postoperatively, and thus the number of candidates that have qualified for the particular ERAS program.

Of those qualified candidates, the ERAS assessment module 16 may then determine the number who completed the ERAS program. For example, the system 1 may include an ERAS completion module 20, such as stored and/or executable on a central computing system 10. ERAS completion module 20 contains instructions executable to determine or identify candidates that completed the ERAS program—namely, those candidates who completed their recovery in the PACU or step-down unit without any need for readmission to the ICU, and/or qualified patients that satisfy a set of completion criteria. Thus, the ERAS completion module 20 may receive clinician input or examine information from a patient's medical record to determine whether the completion criteria are met for a particular ERAS program, such as reaching certain mobility milestones or meeting other criteria within a predetermined amount of time after completion of the surgical procedure. The ERAS completion module 20 may then store an ERAS completion status in the patient record of the ERAS database 18, such as a variable indicating whether the patient 41 did or did not complete the ERAS program. Further, the ERAS completion status may also indicate a reason for non-completion, where non-completion is indicated, such as according to a coding system or a written explanation entered by a clinician.

In certain embodiments, the ERAS assessment module 16 may calculate a qualification ratio based on the number of candidates for the ERAS program and the number of candidates that satisfied the ERAS qualification criteria. For example, the qualification ratio may be calculated as the number of candidates that set aside the ERAS qualification criteria divided by the total number of candidates that qualified for the ERAS program. Similarly, the ERAS assessment module 16 may calculate a completion ratio based on the number of patients who satisfied the ERAS qualification criteria and the number of candidates who completed the ERAS program. For example, the completion ratio may be calculated as the number of candidates who completed the ERAS program divided by the number of patients who satisfied the ERAS qualification criteria. The aforementioned values, including the qualification ratio and the completion ratio, may then be used as assessment tools for determining the efficacy of a particular ERAS program. For example, the values may be used to assess whether the ERAS candidate criteria 29 and/or the ERAS qualification criteria 31 should be adjusted to include a greater number of patients or a fewer number of patients. For instance, if the qualification ratio is extremely low, a healthcare facility may assess whether to raise the ERAS candidate criteria 29 making it more difficult to qualify (and thus qualifying fewer candidates), and/or to lower the ERAS qualification criteria 31 making them easier to meet so that a greater number of candidates actually qualify for the program postoperatively. For example, if the completion ratio is very high, such as near 100%, but the qualification ratio is very low, such as near 50%, that may provide indication that the ERAS qualification criteria 31 are too stringent and that more people should be qualified for the relevant ERAS program, and that people who might otherwise complete the program are being erroneously disqualified postoperatively. In another scenario where the completion ratio is very low but the qualification ratio is very high, a healthcare facility may interpret that as an indication that the ERAS qualification criteria should be made more stringent because patients are qualifying for the ERAS program that are unable to complete it, and thus disqualification of a greater number of patients postoperatively is desirable.

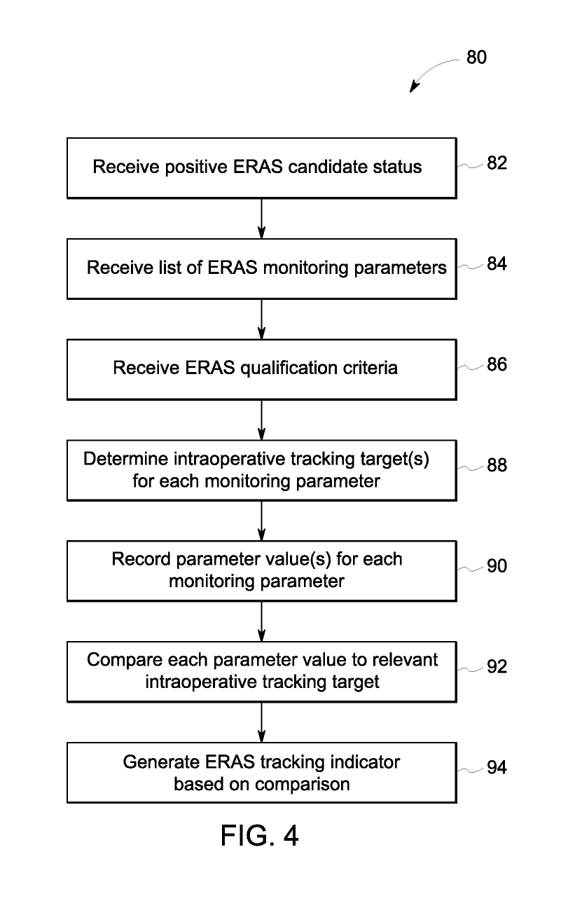

FIG. 4 depicts one embodiment of a method 80 of monitoring a patient 41 during a surgical operation to qualify the patient for an ERAS program. For example, FIG. 4 represents an overview of steps executed by an exemplary embodiment of the ERAS tracking module 14. A positive ERAS candidate status 39 is received at step 82. As described above, certain embodiments of the ERAS tracking module 14 may execute steps to determine the relevant patient's ERAS candidate status 39, such as by receiving ERAS candidate criteria and assessing the patient's medical record or receiving information from the clinician to determine whether the ERAS candidate criteria 29 are met. A list of ERAS monitoring parameters are received at step 84, which will be a list of parameters monitored by the anesthesia assessment system 1 during the course of the surgical operation to track the patient's progress toward qualification for the ERAS program. ERAS qualification criteria are received at step 86, which are the criteria that the patient 41 must meet postoperatively to qualify for the relevant ERAS program. One or more intraoperative tracking targets are determined for each ERAS monitoring parameter at step 88. For example, as described above, tracking targets may be established for each monitoring parameter at each stage of the relevant surgical procedure. Parameter values are then recorded at step 90 for each monitoring parameter. For example, parameter values may be recorded throughout the surgical operation. Each parameter value is compared to a relevant intraoperative tracking target at step 92 to assess the patient's progress and trajectory with respect to postoperatively qualifying for the relevant ERAS program. An ERAS tracking indicator is generated at step 94 based on the comparison to the intraoperative tracking target, such as the ERAS tracking indicators exemplified at FIG. 3B. In certain embodiments, as described above, the ERAS tracking module 14 may further assess parameter values recorded postoperatively to determine whether the candidate meets the ERAS qualification criteria, and thus may automatically determine whether a particular patient postoperatively qualifies for the respective ERAS program.

This written description uses examples to disclose the invention, including the best mode, and also to enable any person skilled in the art to make and use the invention. Certain terms have been used for brevity, clarity and understanding. No unnecessary limitations are to be inferred therefrom beyond the requirement of the prior art because such terms are used for descriptive purposes only and are intended to be broadly construed. The patentable scope of the invention is defined by the claims, and may include other examples that occur to those skilled in the art. Such other examples are intended to be within the scope of the claims if they have features or structural elements that do not differ from the literal language of the claims, or if they include equivalent features or structural elements with insubstantial differences from the literal languages of the claims.

We claim:

1. An anesthesia assessment system for monitoring a patient in an enhanced recovery after surgery (ERAS) program, the system comprising:
an ERAS tracking module executable on a first processor to:
receive identification of ERAS monitoring parameters for monitoring whether the patient is on track to qualify for the ERAS program, wherein the ERAS monitoring parameters includes at least one drug delivery parameter, and/or at least one adequacy of anesthesia parameter, and/or at least one vital sign;
receive one or more ERAS qualification criteria for postoperative qualification for the ERAS program;
determine at least one intraoperative tracking target for each ERAS monitoring parameter of the identified ERAS monitoring parameters, wherein the intraoperative tracking target is a desired value for the respective ERAS monitoring parameter during surgery that pertains to postoperative qualification for the ERAS program;
receive at least one parameter value for each ERAS monitoring parameter during the surgical procedure;
compare each parameter value to the respective intraoperative tracking target;
determine an ERAS tracking indicator based on at least one comparison of the parameter value to the respective intraoperative tracking target, the ERAS tracking indicator indicating whether the patient is on track to meet the ERAS qualification criteria; and
a display that displays the ERAS tracking indicator.

2. The system of claim 1, wherein the ERAS tracking indicator includes a total tracking indicator determined based on a comparison of the at least one parameter value for each of two or more ERAS monitoring parameters to the respective intraoperative tracking target.

3. The system of claim 1, wherein the ERAS tracking indicator includes a parameter tracking indicator determined based on the comparison of the at least one parameter value for one ERAS monitoring parameter to the respective intraoperative tracking target.

4. The system of claim 1, further comprising an ERAS candidate module executable to:
receive ERAS candidate criteria for determining whether the patient is a candidate for the ERAS program; and
determine whether the patient satisfies the ERAS candidate criteria.

5. The system of claim 4, wherein the ERAS candidate module is executable to automatically determine based on the patient's medical record whether the patient satisfies the ERAS candidate criteria.

6. The system of claim 4, wherein the ERAS candidate module is executable to receive user input indicating whether the patient satisfies at least one ERAS candidate criteria in the ERAS candidate criteria.

7. The system of claim 1, wherein the ERAS tracking module is executable to:
record a baseline measurement for at least one ERAS monitoring parameter in the set of ERAS monitoring parameters; and
determine the intraoperative tracking target for the at least one ERAS monitoring parameter based on the baseline measurement.

8. The system of claim 1 wherein the ERAS tracking module is executable to:
receive at least one postoperative parameter value for at least one of the ERAS monitoring parameters;
compare the at least one postoperative parameter value to the ERAS qualification criteria; and
automatically determine an ERAS qualification status based on the comparison.

9. The method of claim 1, further comprising an ERAS database having an ERAS patient record for each candidate for the ERAS program, wherein each ERAS patient record includes an ERAS qualification status indicating whether the patient satisfied the ERAS qualification criteria, and an ERAS completion status indicating whether the patient completed the ERAS program.

10. The method of claim 8, further comprising an ERAS assessment module executable on a second processor to:
determine a number of candidates for the ERAS program, wherein a candidate is a patient that satisfies an ERAS candidate criteria;
determine a number of candidates who satisfied the ERAS qualification criteria;
determine a number of candidates who completed the ERAS program; and
calculate a qualification ratio based on the number of candidates for the ERAS program and the number of candidates who satisfied the ERAS qualification criteria; and
calculate a completion ratio based on the number of patients who satisfied the ERAS qualification criteria and the number of candidates who completed the ERAS program.

11. A method of monitoring a patient during a surgical operation to qualify the patient for an enhanced recovery after surgery (ERAS) program, the method comprising:
identifying that the patient is a candidate for the ERAS program;
receiving one or more ERAS monitoring parameters for monitoring whether the patient is on track to qualify for the ERAS program, wherein the ERAS monitoring parameters include at least one drug delivery parameter, at least one adequacy of anesthesia parameter, and at least one vital sign;
receiving one or more ERAS qualification criteria for postoperative qualification for the ERAS program;
determining at least one intraoperative tracking target for each of the ERAS monitoring parameters, wherein the intraoperative tracking target is a desired value for a respective one of the ERAS monitoring parameters during surgery that pertains to postoperative qualification for the ERAS program;
recording at least one parameter value for each ERAS monitoring parameter during the surgical procedure;
comparing each parameter value to the respective intraoperative tracking target; and
generating a ERAS tracking indicator indicating whether the patient is on track to meet the ERAS qualification criteria based on at least one comparison of the parameter value to the respective intraoperative tracking target.

12. The method of claim 11, wherein the ERAS tracking indicator includes a total tracking indicator determined based on a comparison of the at least one parameter value for each of two or more of the ERAS monitoring parameters to the respective intraoperative tracking target.

13. The method of claim 11, wherein the ERAS tracking indicator includes a parameter tracking indicator determined based on the comparison of the at least one parameter value for one of the ERAS monitoring parameters to the respective intraoperative tracking target.

14. The method of claim 13, wherein the parameter tracking indicator is a first value if the at least one parameter value for the ERAS monitoring parameter is within a first predetermined range of the respective intraoperative tracking target, a second value if the at least one parameter value for the ERAS monitoring parameter is within a second predetermined range of the respective intraoperative tracking target, and a third value if the at least one parameter value for the ERAS monitoring parameter is outside of the second predetermined range of the respective intraoperative tracking target.

15. The method of claim 11, further comprising:
receiving an ERAS candidate criteria;
wherein the step of identifying that the patient is a candidate for the ERAS program includes automatically determining based on the patient's medical record whether the patient satisfies the ERAS candidate criteria.

16. The method of claim 11, further comprising:
receiving an ERAS candidate criteria;
wherein the step of identifying that the patient is a candidate for the ERAS program includes receiving user input indicating whether the patient satisfies at least one ERAS candidate criteria in the set of ERAS candidate criteria.

17. The method of claim 11, further comprising:
recording a baseline measurement for at least one ERAS monitoring parameter in the set of ERAS monitoring parameters; and
determining the intraoperative tracking target for the at least one ERAS monitoring parameter based on the baseline measurement.

18. The method of claim 11, further comprising:
recording in a database whether the patient satisfied the ERAS qualification criteria; and
recording in the database whether the patient completed the ERAS program.

19. The method of claim 18, further comprising:
determining a number of candidates for the ERAS program;
determining a number of patients who satisfied the ERAS qualification criteria;
determining a number of patients who completed the ERAS program; and
calculating a qualification ratio based on the number of candidates for the ERAS program and the number of patients who satisfied the ERAS qualification criteria; and
calculating a completion ratio based on the number of patients who satisfied the ERAS qualification criteria and the number of patients who completed the ERAS program.

20. The method of claim 19, further comprising adjusting at least one of an ERAS candidate criteria for identifying that the patient is a candidate for the ERAS program and the ERAS qualification criteria based on at least one of the qualification ratio and the completion ratio.
